(19) United States
(12) Patent Application Publication
(10) Pub. No.: US 2010/0158768 A1
(43) Pub. Date: Jun. 24, 2010

(54) EXHAUST GAS PURIFYING CATALYST AND EXHAUST GAS PURIFYING APPARATUS

(76) Inventors: Kinichi IWACHIDO, Aichi-gun (JP); Tetsuya Watanabe, Okazaki-shi (JP)

Correspondence Address: BIRCH STEWART KOLASCH & BIRCH, PO BOX 747, FALLS CHURCH, VA, 22040-0747, US

(21) Appl. No.: 12/646,578

(22) Filed: Dec. 23, 2009

(30) Foreign Application Priority Data
Dec. 24, 2008 (JP) P2008-327859

(51) Int. Cl. B01D 53/94; B01J 23/58; B01J 23/44

(52) U.S. Cl. 422/177; 502/328

(57) ABSTRACT

An exhaust gas purifying catalyst includes: a substrate; and a catalyst layer supported on the substrate and including: a surface layer including: rhodium (Rh); and a first support material including zirconia (ZrO2); and an inner surface layer including: palladium (Pd); and a second support material including magnesia (MgO).

### BACKGROUND OF THE INVENTION

The present invention relates to an exhaust gas purifying catalyst and an exhaust gas purifying apparatus.

An exhaust gas purifying apparatus for purifying exhaust gases is provided in an exhaust pipe of an internal combustion engine, for example a gasoline engine, for example. A three-way catalyst is provided in the exhaust gas purifying apparatus. This three-way catalyst removes pollutants from exhaust gases emitted by the gasoline engine which include unburned fuel compounds (hydrocarbons or HC), carbon monoxide (CO) and oxides of nitrogen (NOx) by oxidizing HC and CO and reducing NOx for purification of exhaust gases. Noble metals such as platinum (Pt), palladium (Pd) and rhodium (Rh) are used as catalytic components of the three-way catalyst. Normally, in these noble metals, a catalyst layer includes two or all three components. This is because since the different noble metals have different oxidization activities and reduction activities, the activity of the catalyst is generally improved by utilizing the plurality of noble metals. The utilization of the noble metals in such a way is also intended to reduce a risk involving an increase in price of the noble metals.

With respect to three-way catalysts, efforts have been made to improve support materials (components other than the noble metals) which support the noble metals in the catalyst with a view to reducing the contents of the noble metals by suppressing the growth of noble metal particles. As an improvement in such support materials, there is known a related art in which zirconia (ZrO2), which is a zirconium oxide compound, is used as a support material for Rh (for example, refer to JP-A-2002-518171 (claim 1, FIG. 1 and the like)).

When ZrO2 is used as the support material, however, since a pore volume of ZrO2 is smaller than a pore volume of alumina (Al2O3) which is normally used as a support material, exhaust gases have difficulty in being dispersed to deep portions in a catalyst layer. With such a fact that the dispersion of exhaust gases is made difficult, there is caused a problem that a contact probability that active sites of the catalyst are brought in contact with reaction components of exhaust gases is reduced, which reduces the exhaust gas purifying performance.

### SUMMARY

It is therefore an object of the invention to provide an exhaust gas purifying catalyst in which the contact probability between active sites of the catalyst and reaction components of exhaust gases is made high by the exhaust gases being made easy to be diffused within a catalyst layer and hence the catalyst's exhaust gas purifying performance is increased, and an exhaust bas purifying apparatus which utilizes the catalyst.

In order to achieve the object, according to the invention, there is provided an exhaust gas purifying catalyst comprising:

a substrate; and

a catalyst layer supported on the substrate and including:
a surface layer including:
   rhodium; and
   a first support material including zirconia; and
an inner surface layer including:
   palladium; and
   a second support material including magnesia.

A weight ratio of amount of the rhodium to amount of the first support material may range from 1 to 250 to 1 to 500.

Amount of the rhodium may be in a range from 0.05 g/L to 1.0 g/L relative to volume of the substrate.

Amount of the first support material may be in a range from 25 g/L to 200 g/L relative to volume of the substrate, and amount of the second support material may be in a range from 25 g/L to 200 g/L relative to volume of the substrate.

According to the invention, there is also provided an exhaust gas purifying apparatus, provided in an exhaust line of an internal combustion engine, and comprising the exhaust gas purifying catalyst.

### BRIEF DESCRIPTION OF THE DRAWINGS

FIG. 1 is a schematic block diagram of an internal combustion engine which includes an exhaust gas purifying apparatus according to an embodiment of the invention.

FIG. 2 is a partially sectional exemplary diagram of a catalyst layer of a three-way catalyst according to the embodiment.

FIG. 3 is a graph showing removing efficiencies of HC and NOx by individual noble metal components after catalysts are subjected to a 16-hour aging at 1000° C.

FIG. 4 is a graph showing non-methane HC discharge amounts when a weight ratio between support material amount and supported Rh amount changes.

FIG. 5 is a graph showing a difference in NOx removing efficiency between a surface layer and an inner layer.

FIG. 6 is a graph showing effects of addition of magnesia (MgO).

### DETAILED DESCRIPTION OF EMBODIMENTS

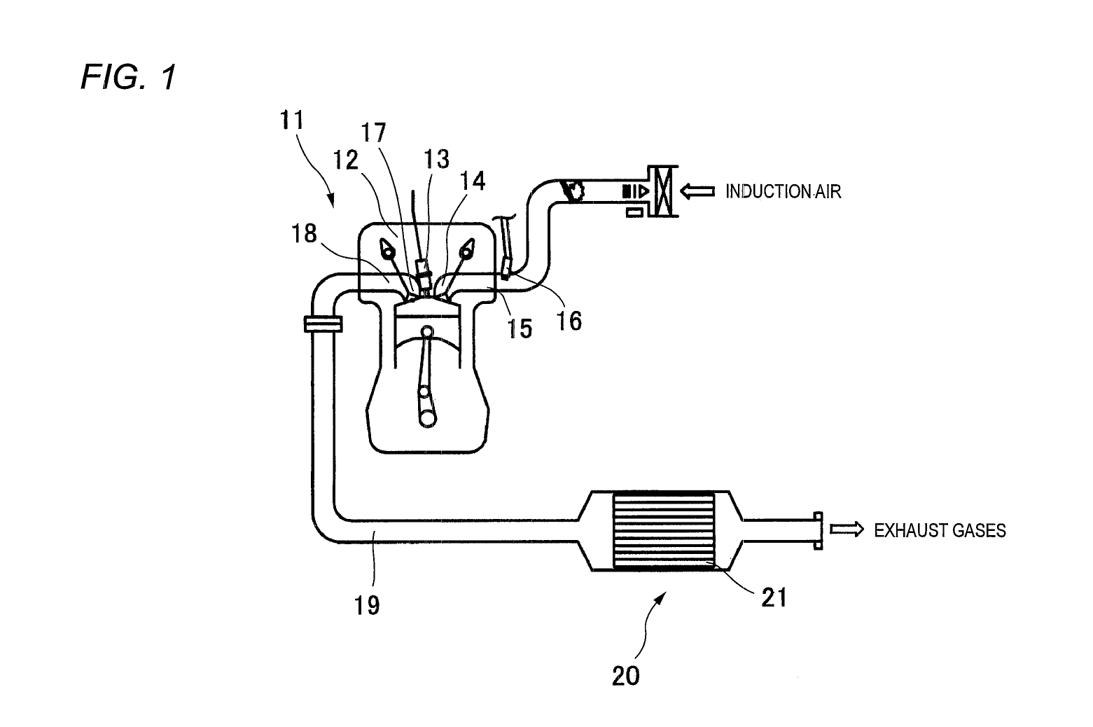

An exhaust gas purifying apparatus of an embodiment of the invention will be described by use of FIG. 1. FIG. 1 is a schematic block diagram of an internal combustion engine (hereinafter, referred to as an engine) which includes an exhaust gas purifying apparatus.

A gasoline engine (hereinafter, referred to simply as an engine) 11 is a multi-point injection engine. A spark plug 13 is mounted in a cylinder head 12 for each cylinder. Induction ports 14 are formed in the cylinder head 12 of the engine 11. An induction manifold 15 is connected to the induction ports 14. Fuel injection valves 16 are provided in the induction manifold 15. Further, exhaust ports 17 are formed in the cylinder head 12. Ends of branch pipes of an exhaust manifold 18 are connected to the exhaust ports 17, and the other ends of the branch pipes of the exhaust manifold 18 are converged for connection to an exhaust pipe 19. An exhaust gas purifying apparatus 20 is provided in the exhaust pipe 19. The exhaust gas purifying apparatus 20 includes a three-way catalyst 21, which is an exhaust gas purifying catalyst.

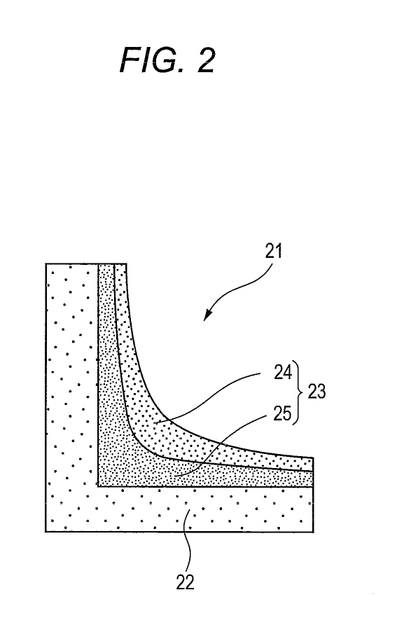

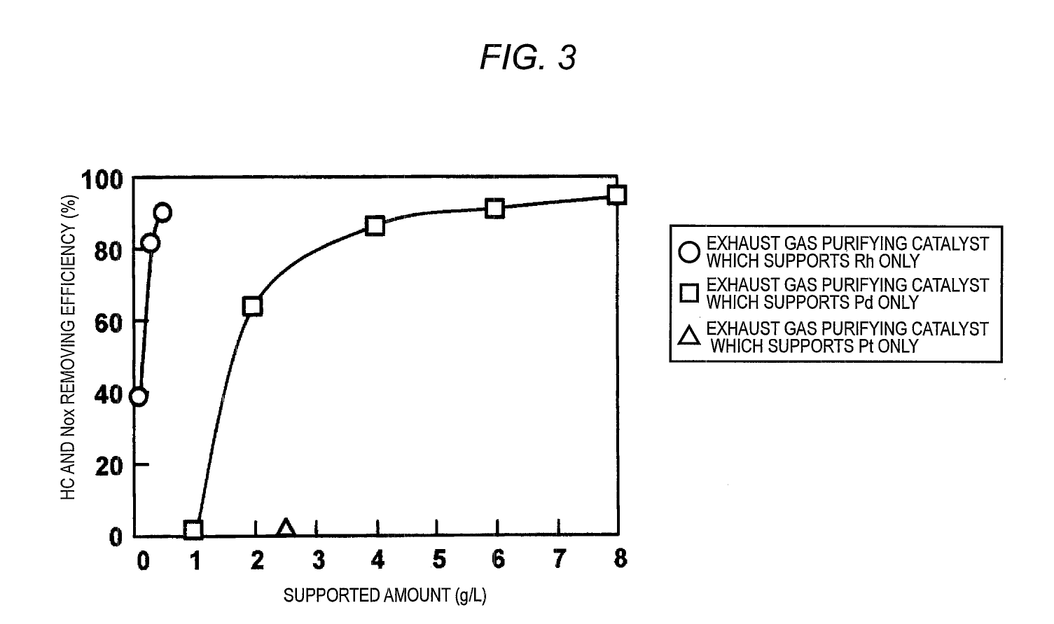

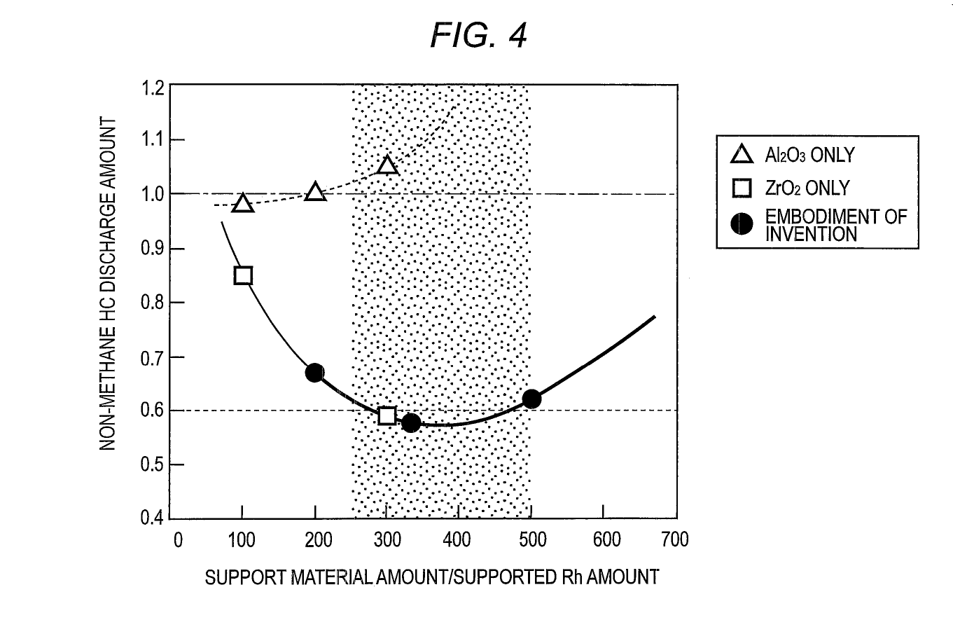

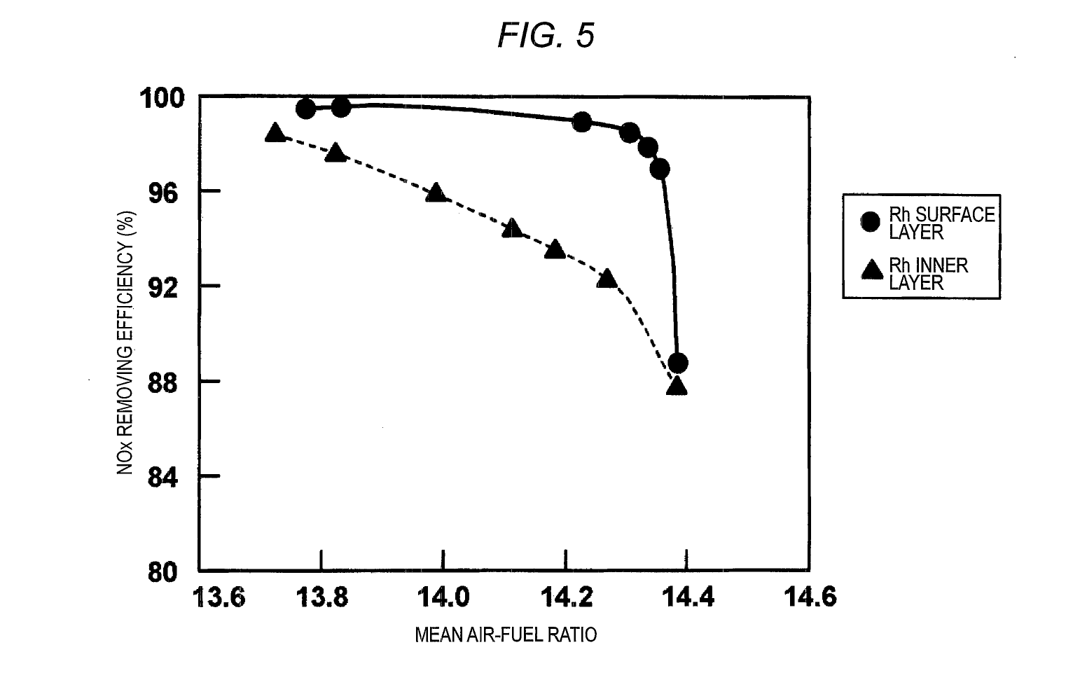

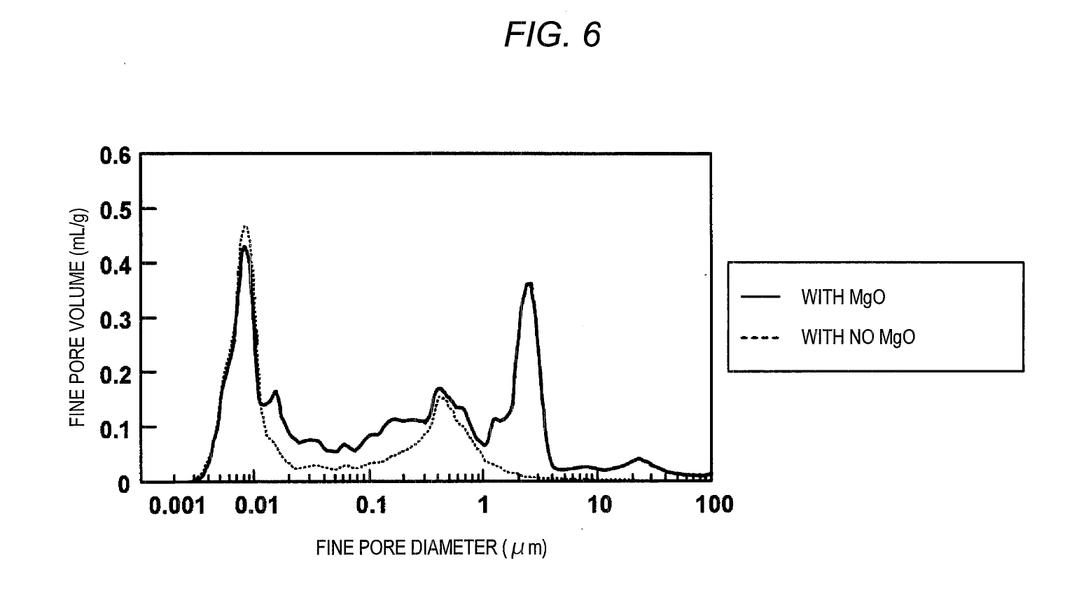

Hereinafter, the three-way catalyst 21 will be described by reference to FIGS. 2 to 6. FIG. 2 is a partially sectional exemplary diagram of a catalyst layer of the three-way catalyst. FIG. 3 is a graph showing removing efficiencies of HC and NOx by individual noble metal components of catalysts after the catalysts are subjected to a 16-hour aging at 1000° C., FIG. 4 is a graph showing non-methane HC discharge amounts when a weight ratio between support material amount and supported Rh amount changes, FIG. 5 is a graph showing a difference in NOx removing efficiency between a surface layer and an inner layer, and FIG. 6 is a graph showing effects of addition of magnesia (MgO).

The three-way catalyst 21 purifies exhaust gases by removing pollutants in the exhaust gases through oxidation of HC and CO and reduction of NOx, which constitute the pollutants in the exhaust gases. The three-way catalyst 21 includes a substrate 22 and a catalyst layer 23 which is supported on the substrate 22.

For the substrate 22, a honeycomb ceramic substrate can be used which has square-cross-section passageways. Note that the material and configuration of the substrate 22 are not limited to those described above, and for example, a metal substrate may be adopted which is made up of flat foils and corrugated foils.

The catalyst layer 23 includes a surface layer 24 and an inner layer 25, as is shown in FIG. 2. The surface layer 24 contains Rh as a noble metal component, and the inner layer 25 contains Pd as a noble metal component. In this embodiment, Rh and Pd which are noble metal components are included in the separate layers so that alloying of Rh with Pd is suppressed, thereby making it possible to suppress reduction in activities of the catalyst components that would otherwise be produced by the alloying of the two noble metal components.

The surface layer 24 will be described. The surface layer 24 contains Rh as the catalyst component. Agglomeration of Rh causes a thermal deterioration or reduction in activity thereof.

In order to suppress this, ZrO2 is added to Al2O3 which is a support material. Note that a mixture may be added in which a rare earth component is mixed with ZrO2 which is a principle ingredient of the mixture. Here, a relationship between supported noble metal amount and removing efficiency will be described by use of FIG. 3. Exhaust gas purifying catalysts shown in FIG. 3 support as noble metal components Rh, Pd, Pt, respectively and have been subjected to a 16-hour aging at 1000° C. In FIG. 3, an axis of ordinate denotes NOx and HC removing efficiency, and this NOx and HC removing efficiency represents a removing performance at a point where HC and NOx cross each other. As is shown in FIG. 3, the exhaust gas purifying catalyst which supports Rh only has a best NOx and HC removing efficiency or exhaust gas purifying performance per supported amount. Containing Rh having the highest exhaust gas purifying performance per supported amount in the surface layer in the way described above improves the overall exhaust gas purifying performance of the catalyst layer 23. In particular, Rh is highly active even in a cold condition where a cold start is carried out, and hence, including Rh into the surface layer is advantageous in increasing the exhaust gas purifying performance immediately after the engine is started.

Further, ceria (CeO2) may be contained as a support material for the surface layer 24. Note that a mixture may be added in which a rare earth component is mixed with CeO2 which is a principle ingredient of the mixture. Containing CeO2 can increase the NOx removing efficiency after the atmosphere has shifted to the lean side.

A content of Rh in the surface layer 24 is preferably in the range from 0.05 g/L to 1.0 g/L and more preferably in the range from 0.1 g/L to 0.6 g/L relative to a substrate volume. In the event that the Rh content is less than 0.05 g/L, the catalyst amount becomes too small, and a desired purifying or removing efficiency cannot be obtained. On the other hand, in the event that the Rh content surpasses 1.0 g/L, an optimum value of the amount of the support materials including ZrO2 becomes too large, and the thickness of the catalyst layer becomes too thick, thereby reducing the engine performance. The amount of the support materials (which include Al2O3, ZrO2 and CeO2) is preferably in the range from 12.5 g/L to 500 g/L and more particularly in the range from 25 g/L to 200 g/L relative to the volume of the substrate. In this case, a weight ratio between the support material amount and the supported Rh amount is preferably made to fall in the range from 250 to 500 to 1. In the event that the weight ratio falls within this range, the diffusivity of exhaust gases can be controlled, and the agglomeration of Rh can be suppressed so as to control the exhaust gas purifying performance as required, thereby making it possible to increase the exhaust gas purifying performance.

This point will be described by use of FIG. 4. FIG. 4 is the graph showing non-methane HC discharge amounts when the amount of the support materials (which include Al2O3, ZrO2 and CeO2) in the surface layer 24 of the embodiment is changed so as to fall within a range which ranges approximately from 100 to 650 times the supported Rh amount. A non-methane HC discharge amount of a catalyst which contains Al2O3 only as a support material is indicated by a broken line for the same of comparison. Non-methane HC means HC which contains no methane (CH4).

As is shown in FIG. 4, the non-methane discharge amount of the catalyst of this embodiment in which the aforesaid support materials are contained in the surface layer 24 is less than the non-methane discharge amount of the comparison catalyst which contains Al2O3 only.

In particular, the non-methane HC discharge amount is 0.6 or less while the support material amount stays in the range from 250 to 500 times the supported Rh amount, thereby making it possible to obtain a desired exhaust gas purifying performance. This is because, in the event that the support material amount becomes less than 250 times the supported Rh amount, Rh cannot be dispersed highly and the Rh particles tend to grow. In the event that the support material amount becomes larger than 500 times the supported Rh amount, the support materials become too much to maintain the desired diffusivity of the exhaust gas, which is then decreased. In addition, in the event that the support material amount becomes larger than 500 times the supported Rh amount, the temperature rising performance of the catalyst is decreased, and therefore, it is considered that the exhaust gas purifying performance in the cold state is decreased. Consequently, in order to obtain the desired exhaust gas purifying performance which is advantageous in decreasing the non-methane HC discharge amount, the support material amount preferably stays in the range from 250 to 500 times the supported Rh amount.

The inner layer 25 contains Pd as the catalyst component and also contains magnesia (MgO) which is added to Al2O3, which is the base material, as an additive. Here, the gas diffusivity of a catalyst layer (which does not contain MgO) made up of two layers will be described based on FIG. 5. FIG. 5 is the graph showing NOx removing efficiencies against mean air-fuel ratio in the event of a catalyst layer (a catalyst active layer) being provided in a surface layer and in the event of the same catalyst layer being provided in an inner layer. As is shown in FIG. 5, in the event that the catalyst layer is provided in the inner layer, the purifying efficiency is decreased, compared with the event of the catalyst layer being provided in the surface layer. This is because in the catalyst layer made up of the two layers, since exhaust gases have difficulty in being diffused to the inner layer, the removing efficiency is decreased. In particular, in this embodiment, since ZrO2, which has low gas diffusivity, is formed on the surface layer, a total amount of exhaust gases which are diffused more deeply into the inner layer side is small.

In contrast to this, in the embodiment, as has been described before, MgO is added to Al2O3 which is the support material of the inner layer. By MgO being added, larger pores can be provided in the inner layer 25 when the catalyst is calcined, whereby exhaust gases are allowed to be diffused to deeper portions in the inner layer 25. A mean particle size of MgO is in the range from 1 μm to 3.0 μm before the catalyst is calcined, and by the catalyst being calcined, more pores whose size ranges approximately from 1 μm to 10 μm are formed in the inner layer 25 than when no MgO is added, as is shown in FIG. 6, and in particular, there are formed many pores whose size ranges approximately from 1 μm to 4 μm. Namely, in the catalyst in which MgO is added in the way described above, the gas diffusivity is improved. The exhaust gas diffusivity can be improved by the pore volume being increased by the addition of MgO, as a result of which the exhaust gas purifying performance can be improved.

Further, CeO2 may be contained in the inner layer 25 as the support material. Note that a mixture may be added in which a rare earth component is mixed with CeO2 which is a principle ingredient of the mixture. Containing CeO2 can improve the NOx removing efficiency after the atmosphere is shifted to the lean side.

A content of Pd in the inner layer 25 is preferably in the range from 0.05 g/L to 20.0 g/L and more preferably in the range from 0.2 g/L to 10.0 g/L relative to the substrate volume. In the event that the content is less than 0.05 g/L, the amount of catalyst becomes too small to carry out exhaust gas purification. On the other hand, in the event that the content surpasses 20 g/L, the Pd amount becomes too much, which promotes the agglomeration of Pd and increases the catalyst costs, this being unacceptable. The amount of the support materials (Al2O3, MgO and CeO2) in the inner layer 25 is preferably in the range from 25 g/L to 300 g/L and more preferably in the range from 25 g/L to 200 g/L relative to the substrate volume.

Thus, as has been described heretofore, in the embodiment, the exhaust gas purifying performance is improved by suppressing the alloying of the noble metals to thereby suppress the reduction in catalyst activity through impregnation of Rh and Pd into the separate layers. As this occurs, the exhaust gas purifying performance is improved by including Rh in the surface layer 24, and the diffusivity of gases are improved by including MgO in the inner layer 25 so that exhaust gases can reach deep portions in the inner layer 25, whereby the exhaust gas purifying performance is improved.

The overall supported catalyst amount of the catalyst layer 23 is preferably in the range from 50 g/L to 400 g/L relative to the substrate volume.

A catalyst fabrication method will be as follows, for example. Slurries for the surface layer 24 and the inner layer 25 are prepared individually. Specifically, a water-soluble Rh salt, Al2O3, CeO2 and ZrO2 are dissolved or dispersed in water, and the solution or dispersion is wet-milled into slurry, whereby slurry for the surface layer 24 is prepared. Similarly, a water-soluble Pd salt, Al2O3, CeO2 and MgO are dissolved or dispersed in water, and the solution or dispersion is wet-milled into slurry, whereby slurry for the inner layer 25 is prepared. Then, a substrate is immersed in the slurry for the inner layer 25, and the substrate from which excess slurry has been removed is dried and calcined, whereby an inner layer 25 is formed. Following this, the substrate on which the inner layer 25 is formed is immersed in the slurry for the surface layer 24, and the substrate from which excess slurry has been removed is dried and calcined, whereby a surface layer 24 is formed. A drying temperature ranging from 100° C. to 250° C. and a calcining temperature ranging from 350° C. to 650° C. can preferably be used when drying and calcining the substrate. The exhaust gas purifying catalyst including the two layers according to the embodiment is formed in the way described above.

Although the exhaust gas purifying apparatus of the invention has been described as being provided in the exhaust line of the multi-point injection gasoline engine, the exhaust purifying apparatus of the invention can also be applied to an exhaust line of an in-cylinder direction injection gasoline engine in which fuel can directly be injected into cylinders of the engine.

According to an aspect of the invention, since the alloying of Rh with Pd is suppressed to thereby suppress the reduction in their activities, the exhaust gas purifying performance becomes high. Since the highly active Rh is included in the surface layer, the high exhaust gas purifying performance is provided even in the cold state in which the catalyst temperature is low as when the engine is started, for example. Further, since ZrO2 is included in the surface layer, the reduction in activity of Rh can be suppressed. As this occurs, although the exhaust gas diffusivity of the surface layer is decreased because ZrO2 has the small pore volume, in the invention, since the catalyst layer has the two-layer construction and MgO is added to the inner layer, the high exhaust gas diffusivity is maintained also in the inner layer. Because of this, since exhaust gases can reach deeper portions in the inner layer, the exhaust gas diffusivity is high as the whole of the catalyst layer, as a result of which the exhaust gas purifying performance becomes high.

According to an aspect of the invention, there is provided a superior advantage that exhaust gases are made easy to be diffused and the exhaust gas purifying performance is high. According to the exhaust gas purifying apparatus which utilizes the exhaust gas purifying catalyst, there can be obtained a superior advantage that the exhaust gas purifying performance becomes high.

The exhaust gas purifying catalyst of the invention can be used in an automotive exhaust gas purifying apparatus, for example. Consequently, the invention can be applied to the automobile manufacturing industry.

What is claimed is:

1. An exhaust gas purifying catalyst comprising:
a substrate; and
a catalyst layer supported on the substrate and including:
a surface layer including:
rhodium; and
a first support material including zirconia; and
an inner surface layer including:
palladium; and
a second support material including magnesia.

2. The exhaust gas purifying catalyst according to claim 1, wherein
a weight ratio of amount of the rhodium to amount of the first support material ranges from 1 to 250 to 1 to 500.

3. The exhaust gas purifying catalyst according to claim 1, wherein
amount of the rhodium is in a range from 0.05 g/L to 1.0 g/L relative to volume of the substrate.

4. The exhaust gas purifying catalyst according to claim 1, wherein
amount of the first support material is in a range from 25 g/L to 200 g/L relative to volume of the substrate, and
amount of the second support material is in a range from 25 g/L to 200 g/L relative to volume of the substrate.

5. An exhaust gas purifying apparatus, provided in an exhaust line of an internal combustion engine, and comprising the exhaust gas purifying catalyst according to claim 1.
